(19) United States
(12) Patent Application Publication
(10) Pub. No.: US 2009/0163317 A1
(43) Pub. Date: Jun. 25, 2009

(54) Power Output Apparatus, Vehicle Provided With the Same, and Method of Controlling the Same

(75) Inventors: Hideaki Goda, Aichi-ken (JP); Kensuke Kamichi, Aichi-ken (JP); Norihiro Iwase, Aichi-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 11/989,546

(22) PCT Filed: Dec. 19, 2006
(86) PCT No.: PCT/IB2006/003692

§ 371 Date: Jan. 28, 2008

(30) Foreign Application Priority Data
Dec. 22, 2005 (JP) 2005-369954

(51) Int. Cl. B60K 1/04

(52) U.S. Cl. 477/3; 180/65.275

(57) ABSTRACT

In a vehicle having a planetary gear mechanism to which an engine, a first motor, a drive shaft and a second motor are connected, while the engine is stopped, an increase rate (ΔTr) by which required torque (Tr*), which is the torque required to be output to a drive shaft, is allowed to increase, is set based on an output limit (Wout) of a battery and an actual torque (T*) is set with the required torque (Tr*) limited by the set increase rate (ΔTr) (S150, S160). A torque limit (Tmax) of the second motor is set by dividing the output limit (Wout) by the rotational speed of the second motor, and control is performed so that the actual torque (T*) is output from the second motor with the upper limit of the torque limit (Tmax) (S260 to S290).

### BACKGROUND OF THE INVENTION

1. Field of the Invention

The present invention relates to a power output apparatus for outputting motive power to a drive shaft, a vehicle on which the power output apparatus is mounted and in which an axle is connected to the drive shaft, and a method of controlling a power output apparatus.

2. Description of the Related Art

As a power output apparatus of this kind, one that is mounted on a hybrid vehicle, and includes: an engine; a planetary gear mechanism, in which a carrier is connected to a crankshaft of the engine, and a ring gear is connected to the drive shaft that is connected to an axle; a first motor that is connected to a sun gear of the planetary gear mechanism; a second motor connected to the drive shaft; and a battery that supplies and receives electric power to and from the two motors has already been available (see Japanese Patent Application Publication No. JP-A-2004-343935, for example). JP-A-2004-343935 says that, while the engine is stopped, the usable electric power that can be supplied to the second motor is determined by adding the electric power generated by the first motor for cranking to the output limit of the battery, and the motor is driven by the electric power equal to or below the usable electric power, so that it is possible to efficiently use the battery and the two motors at the time of starting engine.

The power output apparatus described above controls the operation of the second motor so that the output limit of the battery is not exceeded. In performing this control, because the torque that can be output from the second motor decreases with increase in the rotational speed of the second motor, although large torque is output from the second motor while the vehicle is stopped or runs at a low speed, the torque output from the second motor starts to be limited and the torque output to the drive shaft drops as the vehicle speed increases thereafter, depending on the output limit. When the engine is started and the torque from the engine is output to the drive shaft under this situation, the torque output to the drive shaft suddenly varies. Such sudden variation in the torque causes a shock in the vehicle, and it is preferable to minimize such sudden variation.

### SUMMARY OF THE INVENTION

A power output apparatus, a vehicle on which the power output apparatus is mounted, and a method of controlling a power output apparatus of the present invention aim to achieve suppression of the occurrence of the torque shock that accompanies the start of the engine.

The power output apparatus, the vehicle on which the power output apparatus is mounted, and the method of controlling a power output apparatus of the present invention adopt the following features to achieve the above object.

A power output apparatus according to a first aspect of the present invention is a power output apparatus for outputting motive power to a drive shaft, including: an internal combustion engine that outputs motive power to the drive shaft; a motor that outputs motive power to the drive shaft; an electricity storage means for supplying and receiving electric power to and from the motor; an output limit setting means for setting an output limit of the electricity storage means based on the status of the electricity storage means; a required torque setting means for setting a required torque required to be output to the drive shaft; an increase amount setting means for, while the internal combustion engine is stopped, setting the amount of increase in the torque to be output to the drive shaft in response to the increase in the required torque, based on the set output limit of the electricity storage means, until the internal combustion engine is started; and a control means for, while the internal combustion engine is stopped, performing drive control of the motor so that the torque corresponding to the set required torque is output to the drive shaft, wherein the torque is limited by the set amount of increase and the set output limit of the electricity storage means, and, while the internal combustion engine is in operation, performing drive control of the internal combustion engine so that the torque corresponding to the set required torque is output to the drive shaft using at least the motive power output from the internal combustion engine.

In the power output apparatus according to the first aspect, an output limit of the electricity storage means is set based on the status of the electricity storage means for supplying and receiving electric power to and from the motor that outputs motive power to the drive shaft; a required torque required to be output to the drive shaft is set; while the internal combustion engine that can output motive power to the drive shaft is stopped, the amount of increase in the torque to be output to the drive shaft in response to the increase in the required torque is set based on the set output limit of the electricity storage means, until the internal combustion engine is started: and, while the internal combustion engine is stopped, drive control of the motor is performed so that the torque corresponding to the set required torque is output to the drive shaft, wherein the torque is limited by the set amount of increase and the set output limit of the electricity storage means, and, while the internal combustion engine is in operation, drive control of the internal combustion engine is performed so that the torque corresponding to the set required torque is output to the drive shaft using at least the motive power output from the internal combustion engine. Specifically, when the torque that is output to the drive shaft is increased while the internal combustion engine is stopped, the torque is increased by the amount equal to or less than the increase amount based on the output limit of the electricity storage means. Accordingly, the torque output to the drive shaft is smoothly increased before and after starting the engine. As a result, it is possible to suppress the occurrence of the torque shock that accompanies the start of the internal combustion engine.

In the power output apparatus according to the first aspect, the increase amount setting means may set the amount of increase in the torque to be output to the drive shaft to a smaller value in proportion to decrease in the electric power that the electricity storage means can output under the set output limit of the electricity storage means.

According to the above aspect, it is possible to suppress the occurrence of the torque shock that accompanies the start of the internal combustion engine even when the electric power that the electricity storage means can output is low.

In the power output apparatus according to the above aspect, the control means may be such that, while the internal combustion engine is in operation, the control means performs drive control of the internal combustion engine and the motor so that the torque corresponding to the set required torque is output to the drive shaft, wherein the torque is limited by the set output limit of the electricity storage means.

The power output apparatus according to the above aspect may further include: a starting means for starting the internal combustion engine using the electric power supplied from the electricity storage means; and a first output limit correction means for, when an instruction to start the internal combustion engine is given, correcting the output limit of the electricity storage means set by the output limit setting means, to increase the electric power that can be output, until starting the internal combustion engine is completed. In this case, the control means may be such that, when an instruction to start the internal combustion engine is given, the control means performs drive control of the starting means, the internal combustion engine and the motor so that the internal combustion engine is started and the torque corresponding to the set required torque is output to the drive shaft, using the electric power limited by the corrected output limit of the electricity storage means.

According to the above aspect, it is possible to suppress the drop in the torque output from the motor to the drive shaft that is caused due to the electric power consumption by the starting means while the internal combustion engine is cranked.

The power output apparatus according to the above aspect may further include: a second output limit correction means for setting first and second output limits based on the set output limit of the electricity storage means by correcting the set output limit of the electricity storage means so that the second output limit has a margin relative to the first output limit. In this case, the control means may include: a primary control means for setting a torque command value of the motor so that the torque corresponding to the set required torque is output to the drive shaft, wherein the torque is limited by the set first output limit; and a drive control means for performing drive control of the motor based on a resultant torque command value that is obtained by subjecting the set torque command value to predetermined variation moderation processing, wherein the torque is limited by the set second output limit.

According to the above aspect, even if some time is required from the time when the torque command value of the motor is set by the primary control means while the internal combustion engine is cranked to the time when the drive control means performs drive control of the motor, it is possible to avoid causing the drive control means to perform drive control of the motor without any variation moderation processing, so that it is possible to suppress the occurrence of the shock. The “predetermined variation moderation processing” herein includes smoothing processing and rate processing. In this case, the second output limit correction means may correct the set output limit of the electricity storage means wherein the margin is increased in proportion to decrease in the electric power that the electricity storage means can output. In this way, it is possible to avoid causing the drive control means to perform drive control of the motor without any variation moderation processing more surely.

In the power output apparatus according to the above aspect, the starting means may be a means for outputting/receiving electric power and motive power that is connected to an output shaft of the internal combustion engine and the drive shaft, that cranks the internal combustion engine, and that outputs at least part of the motive power from the internal combustion engine to the drive shaft while outputting and receiving electric power and motive power. In this case, the means for outputting/receiving electric power and motive power may include: three-shaft motive-power outputting/receiving means that is connected to the three shafts of the output shaft of the internal combustion engine, the drive shaft and a third rotary shaft, and that outputs or receives motive power via one of the three shafts based on the motive power that the remaining shafts receive or output; and a motor generator that outputs and receives motive power to and from the third rotary shaft. The means for outputting/receiving electric power and motive power may be a double-rotor motor that includes a first rotor connected to the output shaft of the internal combustion engine, and a second rotor connected to the drive shaft, and produces rotational motion using the relative rotation between the first rotor and the second rotor.

A vehicle according to a second aspect of the present invention is provided with one of the power output apparatuses according to the above aspects of the present invention, more specifically, basically, a power output apparatus for outputting motive power to a drive shaft, including: an internal combustion engine, that outputs motive power to a drive shaft; a motor that outputs motive power to the drive shaft; an electricity storage device for supplying and receiving electric power to and from the motor; an output limit setting section for setting an output limit of the electricity storage device based on the status of the electricity storage device; a required torque setting section for setting a required torque required to be output to the drive shaft; an increase amount setting section for, while the internal combustion engine is stopped, setting the amount of increase in the torque to be output to the drive shaft in response to the increase in the required torque, based on the set output limit of the electricity storage device, until the internal combustion engine is started; and a control section for, while the internal combustion engine is stopped, performing drive control of the motor so that the torque corresponding to the set required torque is output to the drive shaft, wherein the torque is limited by the set amount of increase and the set output limit of the electricity storage device, and, while the internal combustion engine is in operation, performing drive control of the internal combustion engine so that the torque corresponding to the set required torque is output to the drive shaft using at least the motive power output from the internal combustion engine, wherein an axle is connected to the drive shaft.

With regard to a vehicle according to the above aspect, one of the power output apparatuses according to the above aspects of the present invention is mounted on the vehicle, the effects similar to those achieved using the power output apparatus of the present invention are achieved, such as the effect that the torque output to the drive shaft is smoothly increased before and after starting the internal combustion engine, and the effect that it is possible to suppress the occurrence of the torque shock that accompanies the start of the engine.

A method of controlling a power output apparatus according to a third aspect of the present invention is a method of controlling a power output apparatus including: an internal combustion engine that outputs motive power to a drive shaft; a motor that outputs motive power to the drive shaft; and an electricity storage means for supplying and receiving electric power to and from the motor, the method including: (a) setting an output limit of the electricity storage means based on the status of the electricity storage means; (b) setting a required torque required to be output to the drive shaft; (c) while the internal combustion engine is stopped, setting the amount of increase in the torque to be output to the drive shaft in response to the increase in the required torque, based on the set output limit of the electricity storage means, until the internal combustion engine is started; and (d) while the internal combustion engine is stopped, performing drive control of the motor so that the torque corresponding to the set required torque is output to the drive shaft, wherein the torque is limited by the set amount of increase and the set output limit of the electricity storage means, and, while the internal combustion engine is in operation, performing drive control of the internal combustion engine so that the torque corresponding to the set required torque is output to the drive shaft using at least the motive power output from the internal combustion engine.

According to the method of controlling a power output apparatus according to the above aspect, an output limit of the electricity storage means is set based on the status of the electricity storage means for supplying and receiving electric power to and from the motor that outputs motive power to the drive shaft; a required torque required to be output to the drive shaft is set; while the internal combustion engine that outputs motive power to the drive shaft is stopped, the amount of increase in the torque to be output to the drive shaft in response to the increase in the required torque is set based on the set output limit of the electricity storage means, until the internal combustion engine is started; and, while the internal combustion engine is stopped, drive control of the motor is performed so that the torque corresponding to the set required torque is output to the drive shaft, wherein the torque is limited by the set amount of increase and the set output limit of the electricity storage means, and, while the internal combustion engine is in operation, drive control of the internal combustion engine is performed so that the torque corresponding to the set required torque is output to the drive shaft using at least the motive power output from the internal combustion engine. Specifically, when the torque that is output to the drive shaft is increased while the internal combustion engine is stopped, the torque is increased by the amount equal to or less than the increase amount based on the output limit of the electricity storage means. Accordingly, the torque output to the drive shaft is smoothly increased before and after starting the engine. As a result, it is possible to suppress the occurrence of the torque shock that accompanies the start of the internal combustion engine.

### BRIEF DESCRIPTION OF THE DRAWINGS

The foregoing and/or further objects, features and advantages of the invention will become more apparent from the following description of example embodiments with reference to the accompanying drawings, in which the same or corresponding portions are denoted by the same reference numerals and wherein:

FIG. 1 is a configuration diagram showing an outline of the configuration of a hybrid vehicle on which a power output apparatus, which is an embodiment of the present invention, is mounted;

FIG. 2A and FIG. 2B are a flow chart showing an example of a drive control routine executed by a hybrid ECU of the embodiment;

FIG. 3 is an explanatory diagram showing an example of the relations between battery temperature, and an input limit and an output limit in a battery;

FIG. 4 is an explanatory diagram showing an example of the relations between the remaining capacity of the battery, and the correction coefficients of the input limit and the output limit;

FIG. 5 is an explanatory diagram showing an example of a required torque-setting map;

FIG. 6 shows a map showing an example of the relation between the output limit and the increase rate;

FIG. 7 is an explanatory diagram showing an example of a collinear diagram for explaining the dynamics of the rotary elements of a power splitting/combining mechanism at the time of cranking an engine via a motor MG1;

FIG. 8 shows a map showing an example of the relation between the output limit and margin power;

FIG. 9 is a flow chart showing an example of a motor control routine executed by a motor ECU;

FIG. 10 is an explanatory diagram showing an example of the operation line of the engine and the way of setting desired rotational speed and desired torque;

FIG. 11 is an explanatory diagram showing an example of a collinear diagram for explaining the dynamics of the rotary elements of the power splitting/combining mechanism that occurs when the engine is in operation;

FIG. 12 is a configuration diagram showing an outline of the configuration of a hybrid vehicle of a modified embodiment; and

FIG. 13 is a configuration diagram showing an outline of the configuration of a hybrid vehicle of a modified embodiment.

### DETAILED DESCRIPTION OF THE EXAMPLE EMBODIMENTS

Example embodiments for carrying out the present invention will be described below.

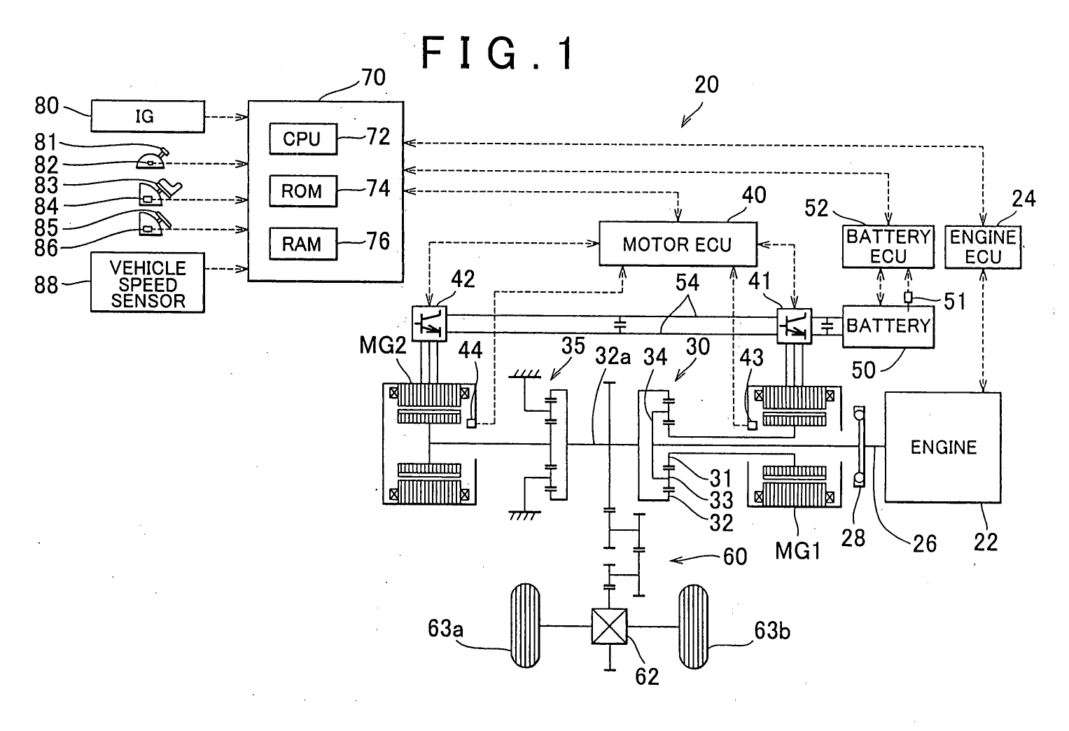

FIG. 1 is a configuration diagram showing an outline of the configuration of a hybrid vehicle 20 on which a power output apparatus, which is an embodiment of the present invention, is mounted. As shown in FIG. 1, the hybrid vehicle 20 of the embodiment includes: an engine 22; a three-shaft power splitting/combining mechanism 30 connected to a crankshaft 26 as an output shaft of the engine 22 with a damper 28 interposed therebetween; a motor MG1 capable of generating electricity that is connected to the power splitting/combining mechanism 30; a speed reduction gear 35 attached to a ring gear shaft 32a as a drive shaft, which is connected to the power splitting/combining mechanism 30; a motor MG2 connected to the speed reduction gear 35; and an electronic control unit 70 for hybrid system (hereinafter referred to as “the hybrid ECU”) that controls the whole power output apparatus.

The engine 22 is an internal combustion engine that generates motive power using hydrocarbon fuel, such as gasoline and light oil. The operation control of the engine 22, such as fuel injection control, ignition control, and intake air amount regulation control, is performed by an electronic control unit 24 for an engine (hereinafter referred to as “the engine ECU”), which receives signals from various sensors for monitoring the operational status of the engine 22. The engine ECU 24 communicates with the hybrid ECU 70. The engine ECU 24 controls the operation of the engine 22 according to the control signal from the hybrid ECU 70, and supplies data on the operational status of the engine 22 to the hybrid ECU 70 as needed.

The power splitting/combining mechanism 30 includes: a sun gear 31, which is an external gear; a ring gear 32, which is an internal gear, disposed concentrically with the sun gear 31; a plurality of pinion gears 33 that engage with the sun gear 31 and the ring gear 32; and a carrier 34 that holds the plurality of pinion gears 33 freely rotatably and revolvably. The power splitting/combining mechanism 30 is structured as a planetary gear mechanism that effects differential motion using the sun gear 31, the ring gear 32, and the carrier 34 as rotary elements. In the power splitting/combining mechanism 30, the crankshaft 26 of the engine 22 is connected to the carrier 34, the motor MG1 is connected to the sun gear 31, and the speed reduction gear 35 is connected to the ring gear 32 with the ring gear shaft 32a interposed therebetween. While the motor MG1 serves as an electric generator, the power splitting/combining mechanism 30 distributes the motive power from the engine 22, which is input via the carrier 34, between the sun gear 31 and the ring gear 32 according to the gear ratios thereof. While the motor MG1 serves as an electric motor, the power splitting/combining mechanism 30 combines the motive power from the engine 22, which is input via the carrier 34, and the motive power from the motor MG1, which is input via the sun gear 31, and outputs the resultant power to the ring gear 32. The motive power output to the ring gear 32 is finally output to driving wheels 63a and 63b of the vehicle via the ring gear shaft 32a, a gear mechanism 60, and a differential gear 62.

Each of the motors MG1 and MG2 is made as a well-known, synchronous motor generator, which is allowed to serve as an electric generator and an electric motor. The motors MG1 and MG2 supply and receive electric power to and from a battery 50 via inverters 41 and 42, respectively. Power lines 54, which connect the battery 50 and the inverters 41 and 42, are constituted of a positive bus and a negative bus, which are shared by the inverters 41 and 42, so that the electric power generated by one of the motors MG1 and MG2 can be used by the other motor. Accordingly, the battery 50 is charged with the electric power generated by one of the motors MG1 and MG2, or is discharged due to electric power shortage. If the electric power consumption and generation is balanced between the motors MG1 and MG2, the battery 50 is neither charged nor discharged. An electronic control unit 40 for motors (hereinafter referred to as “the motor ECU”) performs drive control of the motors MG1 and MG2. The motor ECU 40 receives the signals that are required to perform drive control of the motors MG1 and MG2, such as the signals from rotational position detection sensors 43 and 44 for detecting the rotational positions of the rotors of the motors MG1 and MG2, and the signals indicative of the phase currents applied to the motors MG1 and MG2, which are detected by the current sensors (not shown). The motor ECU 40 outputs switching control signals to the inverters 41 and 42. The motor ECU 40 communicates with the hybrid ECU 70. The motor ECU 40 performs drive control of the motors MG1 and MG2 according to the control signals from the hybrid ECU 70, and supplies data on the operational status of the motors MG1 and MG2 to the hybrid ECU 70 as needed.

An electronic control unit 52 for a battery (hereinafter referred to as “the battery ECU”) manages the battery 50. The battery ECU 52 receives the signals that are required to manage the battery 50, such as the signal indicative of the voltage between the terminals of the battery 50 that is transmitted from a voltage sensor (not shown), which is placed between the terminals of the battery 50, the signal indicative of the charging/discharging current that is transmitted from a current sensor (not shown), which is attached to the power lines 54 connected to the output terminals of the battery 50, and the signal indicative of a battery temperature Tb that is transmitted from a temperature sensor 51, which is attached to the battery 50. The battery ECU 52 supplies the data on the status of the battery 50 to the hybrid ECU 70 via communication means as needed. The battery ECU 52 also calculates the remaining capacity (that is, SOC (state of charge)) from the integrated value of the charging/discharging current detected by the current sensor to manage the battery 50.

The hybrid ECU 70 is constituted of a microprocessor mainly composed of a CPU 72, including, in addition to the CPU 72: a ROM 74 for storing processing programs; a RAM 76 for temporarily storing data; and an I/O port and a communication port (not shown). The hybrid ECU 70 receives, through an input port, the ignition signal from an ignition switch 80, the signal indicative of a shift position SP that is transmitted from a shift position sensor 82 for detecting the shift position of a shift lever 81, the signal indicative of an accelerator pedal operation amount Acc that is transmitted from an accelerator pedal position sensor 84 for detecting the depression amount of an accelerator pedal 83, the signal indicative of a brake pedal position BP that is transmitted from a brake pedal position sensor 86 for detecting the depression amount of a brake pedal 85, and the signal indicative of vehicle speed V that is transmitted from a: vehicle speed sensor 88. As mentioned above, the hybrid ECU 70 is connected to the engine ECU 24, the motor ECU 40, and the battery ECU 52, via the communication port, and supplies and receives various control signals and data to and from the engine ECU 24, the motor ECU 40, and the battery ECU 52.

In the hybrid vehicle 20 of this embodiment configured as described above, the required torque to be output to the ring gear shaft 32a as a drive shaft is calculated from the accelerator pedal operation amount Acc corresponding to the depression amount of the accelerator pedal 83 and the vehicle speed V. The drive control of the engine 22 and the motors MG1 and MG2 is performed so that the required power corresponding to the required torque is output to the ring gear shaft 32a Modes of the drive control of the engine 22 and the motors MG1 and MG2 include a torque conversion operation mode, a charge/discharge operation mode, and a motor drive mode. In the torque conversion operation mode, the engine ECU 24 performs the drive control of the engine 22 so that the motive power corresponding to the required power is output from the engine 22; and the motor ECU 40 performs the drive control of the motors MG1 and MG2 so that the entire motive power output from the engine 22 is output to the ring gear shaft 32a after undergoing torque conversion performed by the power splitting/combining mechanism 30, the motors MG1 and MG2. In the charge/discharge operation mode, the engine ECU 24 performs the drive control of the engine 24 so that the motive power corresponding to the value, which is obtained by adding the electric power to be supplied to the battery 50 to the required power or which is obtained by subtracting the electric power to be discharged from the battery 50 from the required power, is output from the engine 22; and the motor ECU 40 performs the drive control of the motors MG1 and MG2 so that the entire motive power, which is output from the engine 22, or part of the motive power undergoes torque conversion performed by the power splitting/combining mechanism 30, and the motors MG1 and MG2, with the battery 50 charged or discharged, whereby the required power is output to the ring gear shaft 32a. In the motor drive mode, the drive control is performed so that the engine ECU 24 stops the operation of the engine 22, and that the motive power corresponding to the required power that is produced by the motor MG2 is output to the ring gear shaft 32a.

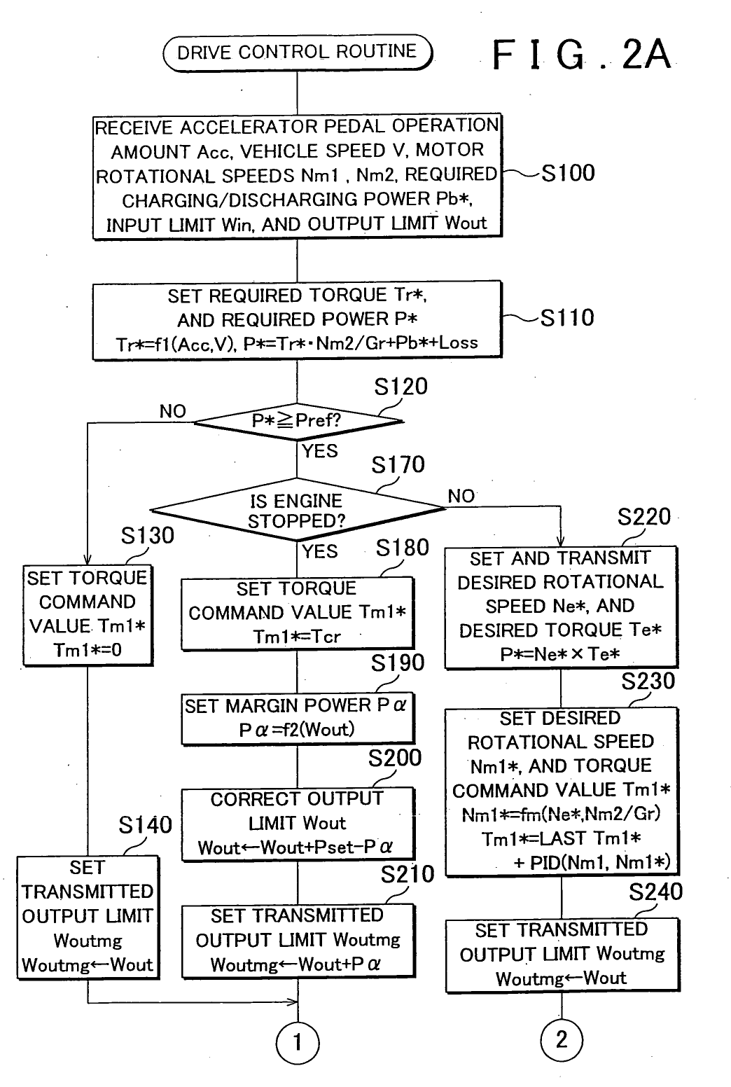

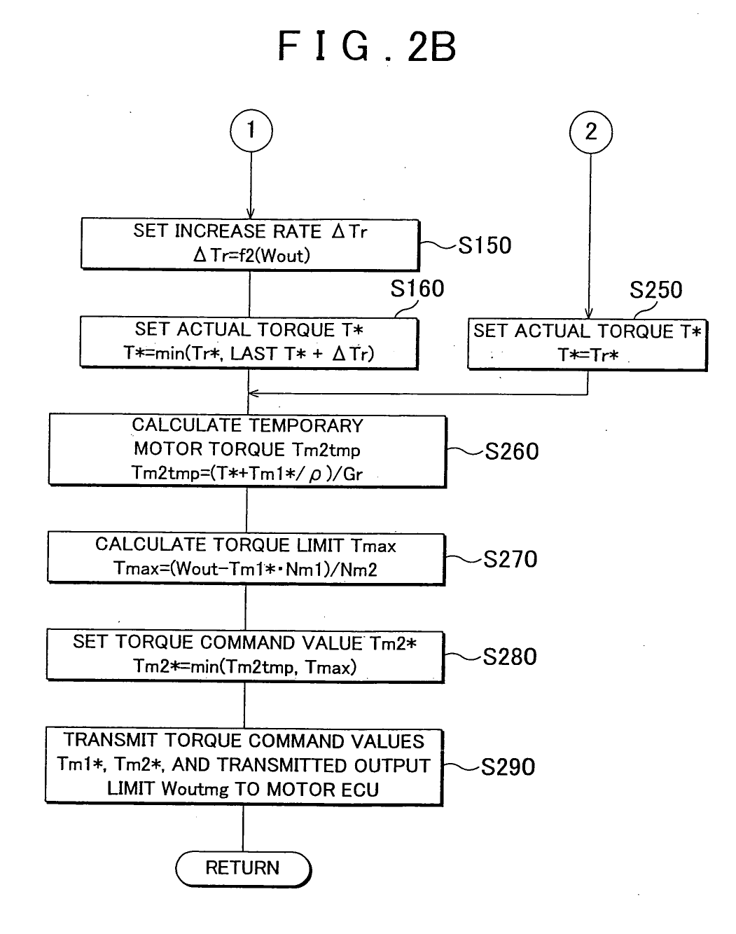

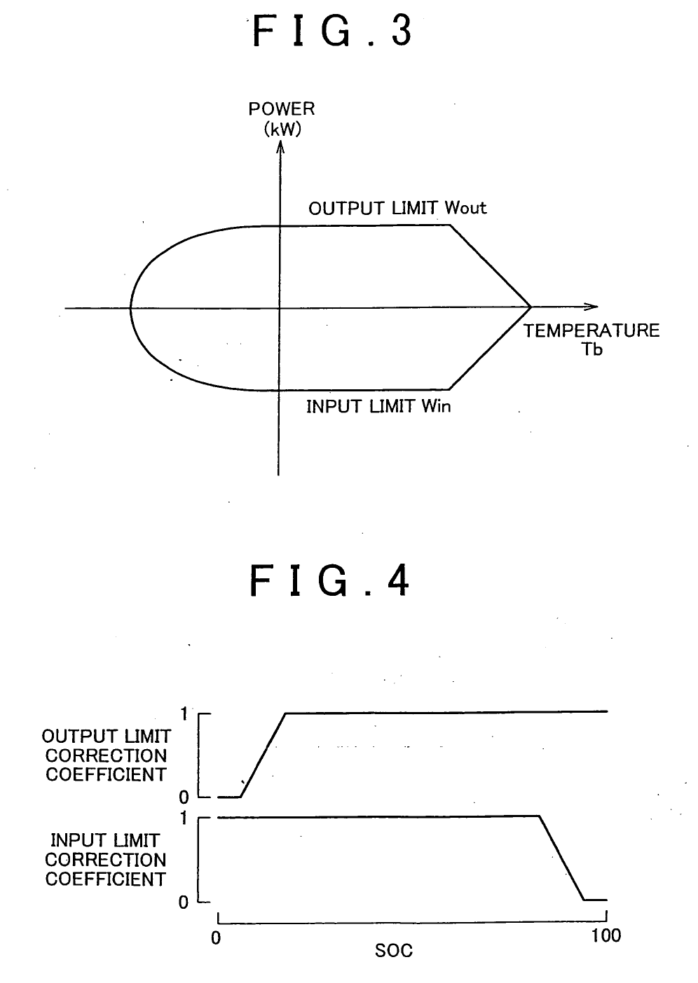

Next, operation of the thus configured hybrid vehicle 20 of this embodiment will be described. FIG. 2A and FIG. 2B are flow chart showing an example of the drive control routine executed by the hybrid ECU 70. The routine is performed at predetermined time intervals (several milliseconds, for example). For the sake of convenience in explanation, the operation performed when the accelerator pedal 83 is depressed by a large amount while the vehicle is stopped, or is running at a low speed (lower than 5 km/h, for example), will be mainly described. When the drive control routine is started, the CPU 72 of the hybrid ECU 70 performs the procedure in which the data required to perform control are input, such as the accelerator pedal operation amount Acc from the accelerator pedal position sensor 84, the vehicle speed V from the vehicle speed sensor 88, the rotational speeds Nm1 and Nm2 of the motors MG1 and MG2, the required charging/discharging power Pb* of the battery 50, and the input limit Win and the output limit Wout of the battery 50 (S100). As the rotational speeds Nm1 and Nm2 of the motors MG1 and MG2, the values calculated based on the rotational positions of the rotors of the motors MG1 and MG2, which are detected by the rotational position detection sensors 43 and 44, are received from the motor ECU 40 via communication means. With regard to the required charging/discharging power Pb* of the battery 50, the value set based on the remaining capacity (SOC) is received from the battery ECU 52 via communication means. With regard to the input limit Win and the output limit Wout of the battery 50, the values set based on the battery temperature Tb of the battery 50, which is detected by the temperature sensor 51, and the remaining capacity (SOC) of the battery 50, are received from the battery ECU 52 via communication means. The input limit Win and the output limit Wout of the battery 50 can be set through the following procedure: basic values of the input limit Win and the output limit Wout are set based on the battery temperature Tb; an output limit correction coefficient and an input limit correction coefficient are set based on the remaining capacity (SOC) of the battery 50; and the thus set basic values of the input limit Win and the output limit Wout are multiplied by the correction coefficients. FIG. 3 shows an example of the relations between the battery temperature Tb, and the input limit Win and the output limit Wout. FIG. 4 shows an example of the relations between the remaining capacity (SOC) of the battery 50, and the correction coefficients of the input limit Win and the output limit Wout.

After the data is received as described above, the CPU 72 of the hybrid ECU 70 sets the required power P* that the vehicle requires, and the required torque Tr* that should be output to the ring gear shaft 32a as a drive shaft that is connected to the driving wheels 63a and 63b, as the torque that the vehicle requires, based on the input accelerator pedal operation amount Acc and the vehicle speed V that the CPU 72 has received (S110). In this embodiment, the relations among the accelerator pedal operation amount Acc, the vehicle speed V, and the required torque Tr* are determined in advance, and stored in the ROM 74 as a required torque-setting map, and, when the accelerator pedal operation amount Acc and the vehicle speed V are provided, the corresponding required torque Tr* is derived from the stored map, and is set as the setting value of the required torque Tr*. FIG. 5 shows an example of the required torque-setting map. The required power P* can be calculated as the sum of the following values: the product of the set, required torque Tr* and the rotational speed Nr of the ring gear shaft 32a; the required charging/discharging power Pb* that the battery 50 requires; and the loss Loss. The rotational speed Nr of the ring gear shaft 32a can be obtained by multiplying the vehicle speed V by the conversion coefficient k, or by dividing the rotational speed Nm2 of the motor MG2 by the gear ratio Gr of the speed reduction gear 35.

After the required power P* is set, the set, required power P* and the threshold value Pref are compared (S120). The threshold value Pref is used to determine whether the engine 22 should be activated, and is set at the lower limit value of the power at which the engine 22 operates efficiently, or a value near the lower limit value. Assuming that the accelerator pedal 83 is depressed by a large amount while the vehicle is stopped, or is running at a low speed, the required torque Tr* takes a large value, whereas the required power P* takes a small value smaller than the threshold value Pref because the vehicle speed V is low. When it is determined that the required power P* is smaller than the threshold value Pref, it is determined that it is unnecessary to activate the engine 22. In this case, the torque command value Tm1*, which specifies the torque to be output from the motor MG1, is set to zero (S130), and the received, output limit Wout is set as the output limit Woutmg to be transmitted (S140). An increase rate ΔTr of the torque to be output to the ring gear shaft 32a is set based on the received, output limit Wout (S150), and the smaller one of the torque obtained by adding the increase rate ΔTr to the last actual torque T* and the required torque Tr* set in step S110 is set as the current actual torque T* (S160).

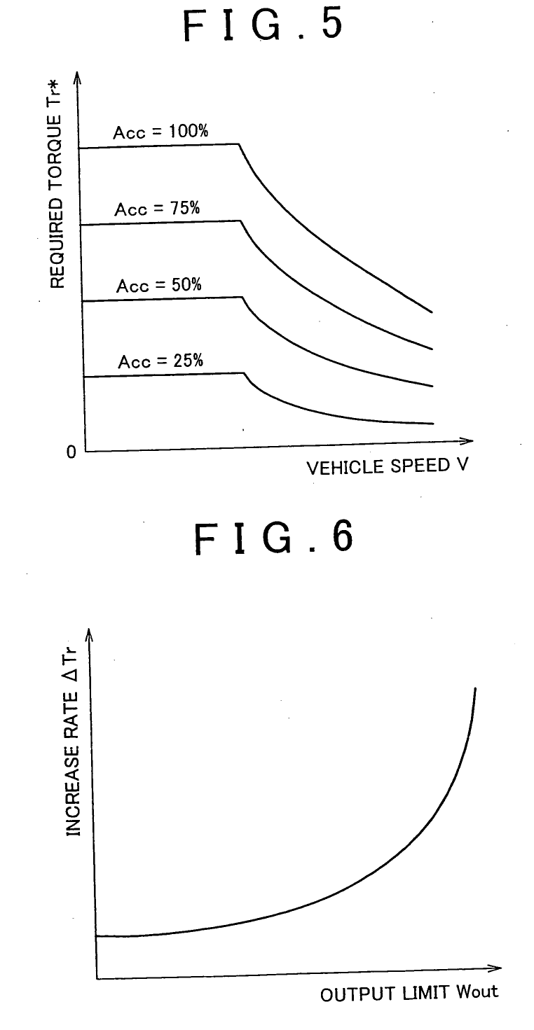

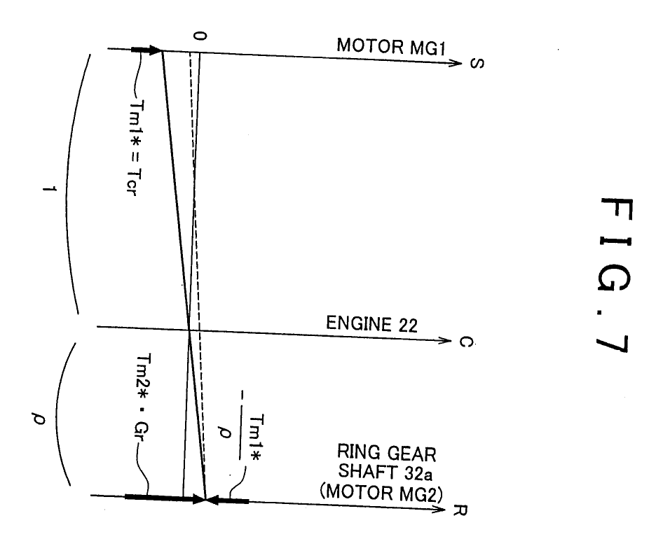

The increase rate ΔTr is defined as the amount of increase per execution time period of this routine (increase gradient) used when the torque to be output to the ring gear shaft 32a as the drive shaft is increased. In this embodiment, the relation between the output limit Wout and the increase rate ΔTr is determined in advance, and stored in the ROM 74 as a map, and, when the output limit Wout is provided, the corresponding increase rate ΔTr is derived from the map, and is set as the setting value of the increase rate ΔTr. An example of this map is shown in FIG. 6. As shown in FIG. 6, the increase rate ΔTr is set so that the increase rate ΔTr decreases as the output limit Wout decreases. In this way, the actual torque T* is set so as to increase by the increase rate ΔTr every execution time period of this routine even if the required torque Tr* is suddenly increased.

When the actual torque T* is set, the value obtained by dividing the set actual torque T* by the gear ratio Gr of the speed reduction gear 35 (T*/Gr) is set as the temporary motor torque Tm2tmp (S260), which is the torque to be output from the motor MG2, and the value obtained by dividing the received, output limit Wout by the rotational speed Nm2 of the motor MG2 (Wout/Nm2) is set as the torque limit Tmax, which is the upper limit of the torque that can be output from the motor MG2 (S270). Thereafter, the value of the temporary motor torque Tm2tmp limited to the torque limit Tmax is set as the torque command value Tm2* of the motor MG2 (S280); and the set, torque command values Tm1* and Tm2*, and the output limit Woutmg to be transmitted are transmitted to the motor ECU 40 (S290). This routine is then exited. The control of the motor ECU 40 that has received the torque command values Tm1* and Tm2*, and the output limit Woutmg to be transmitted will be described later.

Because it is assumed that the accelerator pedal 83 is depressed by a large amount when the vehicle speed V (rotational speed Nm2) is low, the torque limit Tmax (Wout/Nm2) is calculated to be a large value, and decreases with the increase in the vehicle speed V. Accordingly, if the required torque Tr* is set as the actual torque T* without using the increase rate ΔTr, the torque output from the ring gear shaft 32a greatly increases immediately after the accelerator pedal 83 is depressed by a large amount because the torque output from the motor MG2 is not limited by the torque limit Tmax. However, as the vehicle speed V increases, the torque output from the ring gear shaft 32a decreases because the torque output from the motor MG2 starts to be limited by the torque limit Tmax. When the engine 22 is started and starts to produce torque under this condition, the torque output to the ring gear shaft 32a again increases, which causes a torque shock. In this embodiment, the increase rate ΔTr is set so that the increase rate ΔTr decreases as the output limit Wout of the battery 50 decreases, whereby the torque output to the ring gear shaft 32a is gently increased, and the torque output from the motor MG2 is not limited by the torque limit Tmax until the engine 22 is started. Thus, it is possible to avoid starting the engine 22 when the torque output from the motor MG2 is lowered, and to suppress the occurrence of the torque shock that accompanies the start of the engine 22.

When the vehicle speed V (rotational speed Nm2) is increased by the torque output from the motor MG2, and it is therefore determined that the required power P* is equal to or greater than the threshold value Pref in step S120, it is determined whether the operation of the engine 22 is stopped in step S170. If the operation of the engine 22 is stopped (S170), the cranking torque Tcr required to crank the engine 22 is set as the torque command value Tm1* of the motor MG1 (S180). FIG. 7 shows an example of the collinear diagram for explaining the dynamics of the rotary elements of the power splitting/combining mechanism 30 at the time of cranking the engine 22. In FIG. 7, the axis S on the left indicates the rotational speed of the sun gear 31, which is the rotational speed Nm1 of the motor MG1, the axis C indicates the rotational speed of the carrier 34, which is the rotational speed Ne of the engine 22, and the axis R indicates the rotational speed Nr of the ring gear 32, which is obtained by dividing the rotational speed Nm2 of the motor MG2 by the gear ratio Gr of the speed reduction gear 35. The two thick arrows on the axis R indicate the torque that occurs when the torque Tm1* output from the motor MG1 at the time of cranking the engine 22 is transmitted to the ring gear shaft 32a, and the torque that occurs when the torque Tm2* output from the motor MG2 is applied to the ring gear shaft 32a through the speed reduction gear 35.

Subsequently, the margin power Pα is set based on the received output limit Wout (S190); the output limit Wout is corrected by adding the electric power (Pset-Pα), which is obtained by subtracting the margin power Pα from the predetermined temporary up power Pset, to the received output limit Wout (S200); and the output limit Woutmg to be transmitted is set by adding the margin power Pα to the corrected output limit Wout (that is, by adding the temporary up power Pset to the received output limit Wout) (S210). Then, the increase rate ΔTr is set based on the corrected output limit Wout (S150), and the smaller one of the required torque Tr* and the torque that is obtained by increasing the last actual torque T* by the increase rate ΔTr is set as the current actual torque T* (S160).

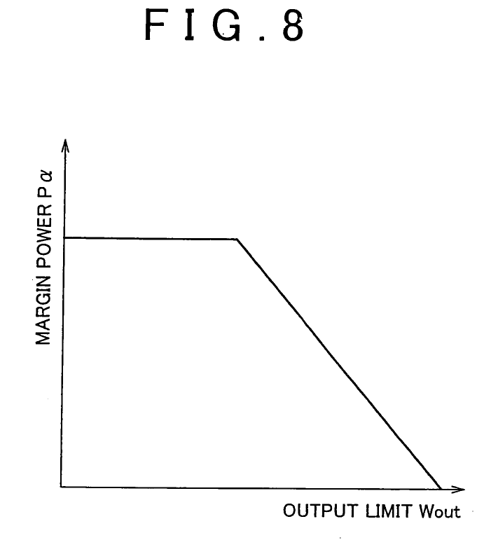

In this embodiment, the relation between the output limit Wout and the margin power Pα is determined in advance, and stored in the ROM 74 as a map, and, when the output limit Wout is provided, the corresponding margin power Pα is derived from the map, and is set as the setting value of the margin power Pα. An example of this map is shown in FIG. 8. In the embodiment, the margin power Pα is set at a smaller power than the temporary up power Pset. The temporary up power Pset is predetermined so that it is possible to output, from the battery 50, the electric power required to crank the engine 22, and, at the same time, it is possible to output, from the battery 50, the electric power required to output the actual torque T* to the ring gear shaft 32a, within a range in which excessive load is not applied to the battery 50.

After the actual torque T* is set in this way, the temporary motor torque Tm2tmp, which is the torque to be output from the motor MG2, is calculated with the following equation (1) using the set actual torque T*, the torque command value Tm1*, and the gear ratio ρ of the power splitting/combining mechanism 30 (S260); and the torque limit Tmax, which is the upper limit of the torque that can be output from the motor MG2, is calculated with the following equation (2) by dividing, by the rotational speed Nm2 of the motor MG2, the difference between the output limit Wout of the battery 50 and the electric power consumed or generated by the motor MG1 which is obtained by multiplying the torque command value Tm1* of the motor MG1 by the current rotational speed Nm1 of the motor MG1 (S270). Then, the torque command value Tm2* of the motor MG2 is set to the value of the temporary motor torque Tm2tmp limited to the calculated torque limit Tmax (S280). The equation (I) can be easily derived from the above-described collinear diagram of FIG. 7.

Tm2tmp=(T*+Tm1*/ρ)/Gr (1)

Tmax=(Wout−Tm1*·Nm1)/Nm2 (2)

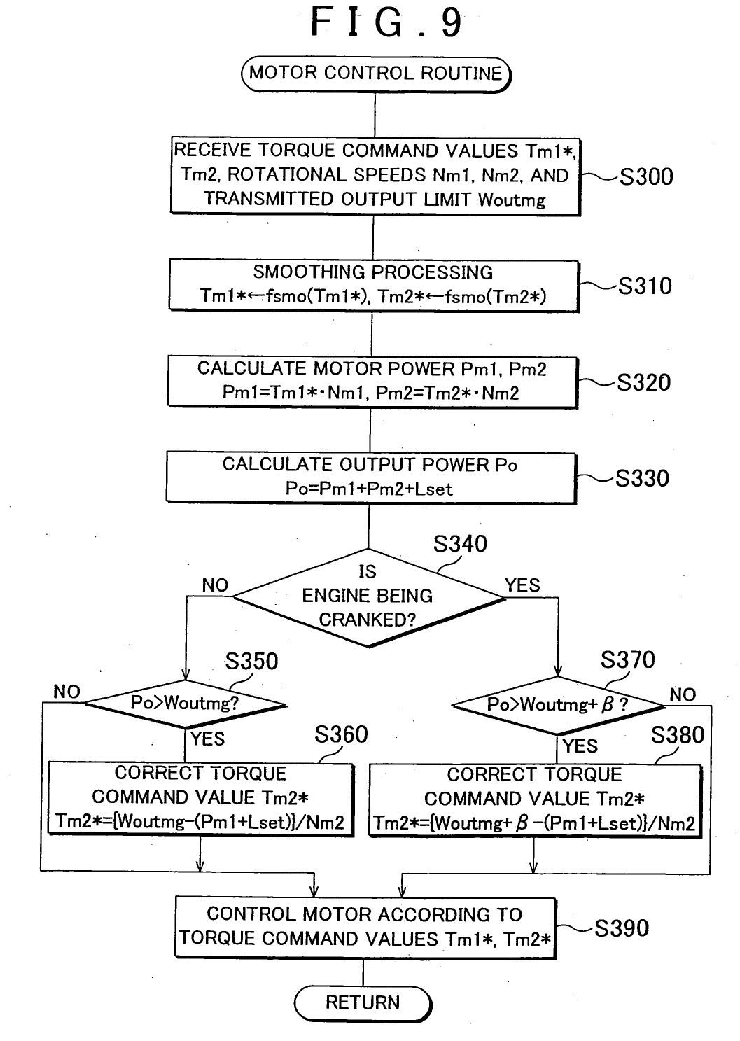

After the torque command values Tm1* and Tm2*, and the output limit Woutmg to be transmitted are set in this way, the set torque command values Tm1* and Tm2*, and the output limit Woutmg to be transmitted are transmitted to the motor ECU 40 (S290), and this routine is then exited. Next, the control performed by the motor ECU 40 that has received the torque command values Tm1* and Tm2*, and the output limit Woutmg to be transmitted will be described. FIG. 9 is a flow chart showing an example of the motor control routine executed by the motor ECU 40. This routine is repeatedly executed every predetermined time period (a few msec, for example).

When the motor control routine is started, the CPU (not shown) of the motor ECU 40 performs the procedure in which the data required to perform control are input, such as the torque command values Tm1* and Tm2* of the motors MG1 and MG2, the rotational speeds Nm1 and Nm2 of the motors MG1 and MG2, and the transmitted output limit Woutmg of the battery 50 (S300). In this embodiment, the motor ECU 40 receives the torque command values Tm1* and Tm2*, and the transmitted output limit Woutmg of the battery 50 that are transmitted by the hybrid ECU 70, and the received data that is written into a predetermined address region in the RAM (not shown) of the motor ECU 40 is used as input data. The rotational speeds Nm1 and Nm2 of the motors MG1 and MG2 that are calculated from the rotational positions of the rotors of the motors MG1 and MG2 detected by the rotational position sensors 43 and 44, and are written into the RAM, are used as input data.

After the data is received as described above, in order to inhibit the sudden change in the torque output from the motors MG1 and MG2, the received torque command values Tm1* and Tm2* are subjected to smoothing processing (S310); and the motor power Pm1 and the motor power Pm2, which are the electric power consumed or generated by the motors MG1 and MG2, respectively, are calculated by multiplying, by the rotational speeds Nm1 and Nm2. the torque command values Tm1* and Tm2* that have been subjected to the smoothing processing (S320). The output power Po of the battery 50 is calculated by adding the loss Lset to the sum of the calculated motor power Pm1 and the calculated motor power Pm2 (S330). Thereafter, it is determined whether the engine 22 is being cranked (S340), and, if it is determined that the engine 22 is not being cranked, the calculated output power Po and the received, output limit Woutmg to be transmitted, which is equal to the output limit Wout in this step, are compared (S350).

Because the torque command values Tm1* and Tm2* are set within the output limit Wout of the battery 50 by the hybrid ECU 70, if the communication delay due to the time required for the hybrid ECU 70 to send a communication to the motor ECU 40 is not considered, the calculated output power Po of the battery 50 is within the output limit Woutmg to be transmitted. However, when the communication delay is taken into consideration, there can be a case where the rotational speeds Nm1 and Nm2 of the motors MG1 and MG2 that occur when the torque command values Tm1* and Tm2* are set by the hybrid ECU 70, are different from the rotational speeds Nm1 and Nm2 of the motors MG1 and MG2 that occur when the motors MG1 and MG2 are controlled by the motor ECU 40.

In this embodiment, the torque command values Tm1* and Tm2* that are set by the hybrid ECU 70 are subjected to the smoothing processing, and, therefore, when the amount of change in the rotational speeds Nm1 and Nm2 of the motors MG1 and MG2 is small, the calculated output power Po of the battery 50 is within the output limit Woutmg to be transmitted even if the communication delay is taken into consideration. However, when the amount of change in the rotational speeds Nm1 and Nm2 are large, there can be a case where the calculated output power Po of the battery 50 exceeds the output limit Woutmg to be transmitted. When the output power Po of the battery 50 is equal to or lower than the output limit Woutmg to be transmitted, it is determined that the electrical discharge from the battery 50 by excessive electric power will be prevented, and switching of the switching elements of the inverters 41 and 42 is controlled so that the torque corresponding to the torque command values Tm1* and Tm2* that are set by the hybrid ECU 70, and have been subjected to the smoothing processing is output (S390). This routine is then exited. When the output power Po of the battery 50 is higher than the output limit Woutmg to be transmitted, it is determined that the electrical discharge from the battery 50 by excessive electric power will occur, the torque command value Tm2* of the motor MG2 is reset based on the following equation (3) so that the output power Po of the battery 50 is within the transmitted output limit Woutmg of the battery 50 (S360). Then, switching of the switching elements of the inverters 41 and 42 is controlled so that the torque corresponding to the torque command value Tm1* that is set by the hybrid ECU 70 and has been subjected to the smoothing processing is output from the motor MG1, and the torque corresponding to the torque command value Tm2* that has been reset is output from the motor MG2 (S390). This routine is then exited. When the output power Po of the battery 50 is higher than the output limit Woutmg to be transmitted, the torque command value Tm2* of the motor MG2 is reset so that the output power Po of the battery 50 is within the output limit Wout of the battery 50 in this embodiment. However, the torque command value Tm1* of the motor MG1 may be reset instead.

Tm2*={Woutmg−(Pm1+Lset)}/Nm2 (3)

If it is determined that the engine 22 is being cranked in step S340, the calculated output power Po and the value obtained by further adding a predetermined margin β to the received, output limit Woutmg to be transmitted, which indicates the electric power obtained by adding the margin power Pα to the output limit Wout corrected in step S200, are compared (S370). When the output power Po is equal to or lower than the value obtained by adding the margin β to the output limit Woutmg to be transmitted, switching of the switching elements of the inverters 41 and 42 is controlled so that the torque corresponding to the torque command values Tm1* and Tm2* that are set by the hybrid ECU 70 and have been subjected to the smoothing processing is output (S390). This routine is then exited. When the output power Po is higher than the value obtained by adding the margin β to the output limit Woutmg to be transmitted, in order to limit the output power Po to the value obtained by adding the margin β to the transmitted output limit Woutmg of the battery 50, the torque command value Tm2* of the motor MG2 is reset with the equation (4) shown below (S380), and switching of the switching elements of the inverters 41 and 42 is controlled so that torque corresponding to the torque command value Tm1* that is set by the hybrid ECU 70 and has been subjected to the smoothing processing is output from the motor MG1, and the torque corresponding to the reset torque command value Tm2* is output from the MG2 (S390). This routine is then exited.

While the motor MG1 is cranking the engine 22, the rotational speed Nm1 of the motor MG1 significantly varies. Accordingly, because of the communication delay between the hybrid ECU 70 and the motor ECU 40, the electric power consumption of the motor MG1 (Tm1*×Nm1) that is calculated by the hybrid ECU 70 is smaller than the electric power consumption of the motor MG1 that is calculated by the motor ECU 40. For this reason, the torque limit Tmax is calculated to be a large value by the hybrid ECU 70 in step S270, so that the torque command value Tm2* of the motor MG2 is not limited by the hybrid ECU 70, but the torque command value Tm2* of the motor MG2 tends to be largely limited by the motor ECU 40. As described above, even if the torque command value Tm2* of the motor MG2 that is set by the hybrid ECU 70 is largely limited, the smoothing processing is then performed by the motor ECU 40, so that no torque shock will occur. However, if the torque command value Tmn2* of the motor MG2 is limited by the motor ECU 40, priority is given to the protection of the battery 50, and, therefore, the smoothing processing is not performed, so that a large torque shock can occur depending on the extent of the limitation of the torque command value Tm2*.

In this embodiment, while the engine 22 is being cranked, the hybrid ECU 70 sets the output limit Woutmg to be transmitted in step S210 by adding the margin power Pa to the output limit Wout that is corrected in step S200, and the motor ECU 40 compares the output power Po and the value obtained by adding the margin β to the output limit Woutmg to be transmitted (Woutmcg+β) in step 370, and determines whether the torque command value Tm2* of the motor MG2 should be limited. In this way, the situation in which, because of the communication delay between the hybrid ECU 70 and the motor ECU 40, the torque command value Tm2* is not limited by the hybrid ECU 70 but largely limited by the motor ECU 40, is avoided to the extent possible, so that the occurrence of the torque shock during the cranking of the engine 22 is prevented. In this embodiment, as the margin β and the margin power Pα, predetermined values are used with which it is possible to avoid applying excessive load to the battery 50 within the time period taken to crank the engine 22.

Tm2*={Woutmg+β−(Pm1+Lset)}/Nm2 (4)

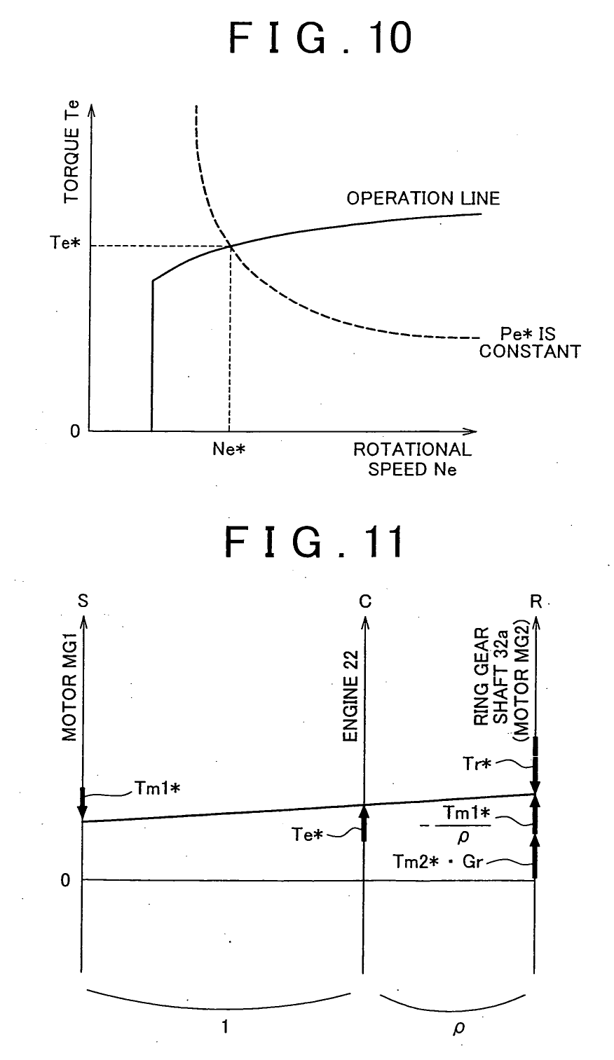

Referring back to the drive control routine of FIG. 2A and FIG. 2B, if it is determined that the cranking of the engine 22 has been completed (the operation of the engine 22 is not stopped) in step S170, the desired rotational speed Ne* of the engine 22 and the desired torque Te* are set based on the set required power P*, and are transmitted to the engine ECU 24 (S220). This setting is performed by setting the desired rotational speed Ne* and the desired torque Te* based on the operation line on which the engine 22 efficiently operates, and the required power P*. An example of the operation line of the engine 22 and the way of setting the desired rotational speed Ne* and the desired torque Te* are shown in FIG. 10. As shown in FIG. 10, the desired rotational speed Ne* and the desired torque Te* can be determined by using the intersection point of the operation line and the curve along which the required power P* (Ne*×Te*) is constant. The engine ECU 24 that has received the desired rotational speed Ne* and the desired torque Te* performs control of the engine 22, such as the fuel injection control and the ignition control, so that the engine 22 is operated at the operational point that is indicated by the desired rotational speed Ne* and the desired torque Te*.

Subsequently, the desired rotational speed Nm1* of the motor MG1 is calculated with the equation (5) shown below using the set, desired rotational speed Ne*, the rotational speed Nr (Nm2/Gr) of the ring gear shaft 32a, and the gear ratio ρ of the power splitting/combining mechanism 30, and the torque command value Tm1* of the motor MG1 is calculated with the equation (6) using the calculated, desired rotational speed Nm1* and the current rotational speed Nm1 (S230). The equation (5) is a mechanical relation relating to the rotary elements of the power splitting/combining mechanism 30. A collinear diagram showing the mechanical relation between torque and the rotational speed of a rotary element of the power splitting/combining mechanism 30 that occurs when the engine 22 is in operation, is shown in FIG. 11. The equation (5) can be easily derived using this collinear diagram. The equation (6) is a relation used in feedback control to rotate the motor MG1 at the desired rotational speed Nm1*. In the equation (6), “k1” of the second term on the right-hand side is the gain of the proportional term, and “k2” of the third term on the right-hand side is the gain of the integral term. After the torque command value Tm1* of the motor MG1 is calculated, the output limit Wout, which is received in step S100, is set as the transmitted output limit Woutmg that is transmitted to the motor ECU 40 (S240), and the required torque Tr* is set as the actual torque T* (S250). Thereafter, the processing in and after step S260 described above is performed, and this routine is then exited.

Nm1*=Ne*·(1+ρ)/ρ−Nm2/(Gr·ρ) (5)

Tm1*=Last Tm1*+k1(Nm1*−Nm1)+k2∫(Nm1*−Nm1)dt (6)

According to the hybrid vehicle 20 of the embodiment described above, while the engine 22 is stopped, the increase rate ΔTr by which the require d torque Tr*, which is the torque required to be applied to the ring gear shaft 32a as the drive shaft, is allowed to increase, is set based on the output limit Wout of the battery 50 until the engine 22 is started. The actual torque T* is set with the required torque Tr* limited by the set increase rate ΔTr, and the torque limit Tmax of the motor MG2 is set by dividing the output limit Wout by the rotational speed Nm2 of the motor MG2. Control is performed so that the actual torque T* is output from the motor MG2 to the ring gear shaft 32a with the upper limit of the torque limit Tmax. Accordingly, it is possible to inhibit the torque that is output to the ring gear shaft 32a from dropping due to the torque limit Tmax while the vehicle speed V is increasing. As a result, when the engine 22 is started afterward, the torque is smoothly increased before and after starting the engine, so that it is possible to suppress the torque shock.

According to the hybrid vehicle 20 of this embodiment, while the motor MG1 is cranking the engine 22, the output limit Wout of the battery 50 is corrected using the temporary up power Pset, so that it is possible to output the actual torque T* to the ring gear shaft 32a even when the electric power required to start the engine 22 is output from the battery 50.

According to the hybrid vehicle 20 of this embodiment, while the motor MG1 is cranking the engine 22, it is determined whether the torque command value Tm2* that is set by the hybrid ECU 70 and has been subjected to the smoothing processing should be limited, based on the electric power limit obtained by adding the margin (margin power Pα, and margin β) to the output limit Wout that is used in the hybrid ECU 70. Accordingly, it is possible to avoid largely limiting the torque command value Tm2* that has not been subjected to the smoothing processing yet to the extent possible, so that it is possible to prevent the occurrence of the torque shock.

Although, in the hybrid vehicle 20 of this embodiment, while the engine 22 is being cranked, the output limit Wout is corrected using the temporary up power Pset, the hybrid vehicle 20 may be such that the correction of the output limit Wout using the temporary up power Pset is not performed.

Although, in the hybrid vehicle 20 of this embodiment, the torque command values Tm1* and Tm2* set by the hybrid ECU 70 are transmitted to the motor ECU 40, and are subjected to the smoothing processing in the motor ECU 40, these values may be subjected to the smoothing processing in the hybrid ECU 70, and transmitted to the motor ECU 40. The processing to which the torque command values Tm1* and Tm2* set by the hybrid ECU 70 are subjected is not limited to the smoothing processing, and may be another variation moderation processing, such as rate processing.

In the hybrid vehicle 20 of this embodiment, while the engine 22 is being cranked, it is determined whether the torque command value Tm2* that is set by the hybrid ECU 70 and has been subjected to the smoothing processing is limited by the motor ECU 40, with the margin power Pα and the margin β for the output limit Wout used in hybrid ECU 70 taken into consideration. However, what is taken into consideration may be one of the margin power Pα and the margin β, or none of these margins may be taken into consideration.

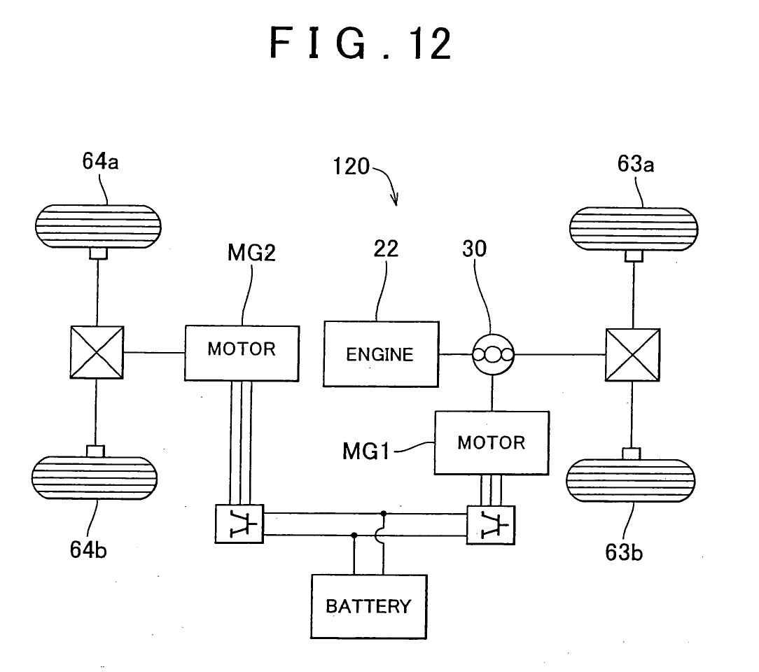

Although, in the hybrid vehicle 20 of this embodiment, the motive power of the motor MG2 is subjected to the speed change via the speed reduction gear 35, and output to the ring gear shaft 32a, the motive power of the motor MG2 may be output to another axle (the axle connected to the wheels 64a and 64b shown in FIG. 12) than the axle (the axle to which the driving wheels 63a and 63b are connected) to which the ring gear shaft 32a is connected, as illustrated by a hybrid vehicle 120 of a modified example shown in FIG. 12.

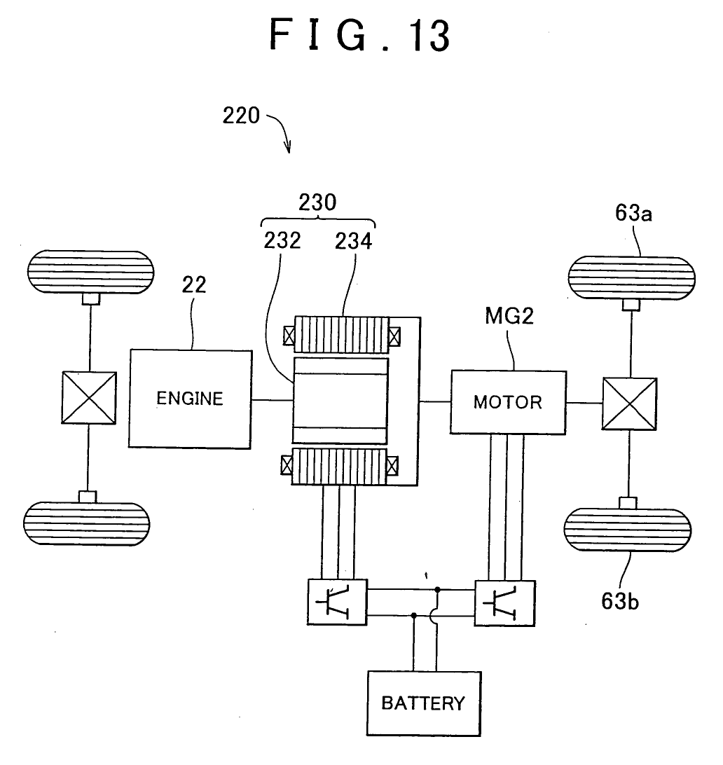

Although, in the hybrid vehicle 20 of this embodiment, the motive power of the engine 22 is output to the ring gear shaft 32a as the drive shaft that is connected to the driving wheels 63a and 63b via the power splitting/combining mechanism 30, the hybrid vehicle according to the present invention may include a double-rotor motor 230 having: an inner rotor 232 that is connected to the crankshaft 26 of the engine 22; and an outer rotor 234 that is connected to the drive shaft that outputs motive power to the driving wheels 63a and 63b, and that transmits part of the motive power of the engine 22 to the drive shaft, and converts the remaining motive power into electric power, as illustrated by a hybrid vehicle 220 of a modified example shown in FIG. 13.

While embodiments of the present invention have been described above, the present invention is not limited to these embodiments, and can be implemented in various forms without departing from the spirit of the present invention.

The present invention can be used in the field of the automobile industry and in the field of the manufacturing industry of the power output apparatus.

1.-12. (canceled)

13. A power output apparatus comprising:
an internal combustion engine that outputs motive power to a drive shaft;
a motor that outputs motive power to the drive shaft;
an electricity storage device that supplies and receives electric power to and from the motor;
an output limit setting section that sets an output limit of the electricity storage device based on the status of the electricity storage device;
a required torque setting section that sets a required torque required to be output to the drive shaft;
an increase amount setting section that, while the internal combustion engine is stopped, sets the amount of increase in the torque to be output to the drive shaft in response to the increase in the required torque, based on the set output limit of the electricity storage device, until the internal combustion engine is started; and
a control section that, while the internal combustion engine is stopped, performs drive control of the motor so that the torque corresponding to the set required torque is output to the drive shaft, wherein the torque is limited by the set amount of increase and the set output limit of the electricity storage device, and, while the internal combustion engine is in operation, performs drive control of the internal combustion engine so that the torque corresponding to the set required torque is output to the drive shaft using at least the motive power output from the internal combustion engine; and
a second output limit correction section that sets first and second output limits based on the set output limit of the electricity storage device by correcting the set output limit of the electricity storage device so that the second output limit has a margin relative to the first output limit,
wherein the control section includes: a primary control section that sets a torque command value of the motor so that the torque corresponding to the set required torque is output to the drive shaft, wherein the torque is limited by the set first output limit; and a drive control section that performs drive control of the motor based on a resultant torque command value that is obtained by subjecting the set torque command value to predetermined variation moderation processing, wherein the torque is limited by the set second output limit.

14. The power output apparatus according to claim 13, wherein the increase amount setting section sets the amount of increase in the torque to be output to the drive shaft to a smaller value in proportion to decrease in the electric power that the electricity storage device can output under the set output limit of the electricity storage device.

15. The power output apparatus according to claim 13, wherein, while the internal combustion engine is in operation, the control section performs drive control of the internal combustion engine and the motor so that the torque corresponding to the set required torque is output to the drive shaft, wherein the torque is limited by the set output limit of the electricity storage device.

16. The power output apparatus according to claim 13, further comprising:
a starting section that starts the internal combustion engine using the electric power supplied from the electricity storage device; and a first output limit correction section that, when an instruction to start the internal combustion engine is given, corrects the output limit of the electricity storage device set by the output limit setting section, to increase the electric power that can be output, until starting the internal combustion engine is completed, wherein, when an instruction to start the internal combustion engine is given, the control section performs drive control of the starting section, the internal combustion engine and the motor so that the internal combustion engine is started and the torque corresponding to the set required torque is output to the drive shaft, using the electric power limited by the corrected output limit of the electricity storage device.

17. The power output apparatus according to claim 13, wherein the second output limit correction section corrects the set output limit of the electricity storage device wherein the margin is increased in proportion to decrease in the electric power that the electricity storage device can output.

18. The power output apparatus according to claim 13, wherein the starting section is an electric power and motive power outputting/receiving section that is connected to an output shaft of the internal combustion engine and the drive shaft, and that outputs at least part of the motive power from the internal combustion engine to the drive shaft while outputting and receiving electric power and motive power.

19. The power output apparatus according to claim 18, wherein the electric power and motive power outputting/receiving section includes: a three-shaft motive-power outputting/receiving section that is connected to the three shafts of the output shaft of the internal combustion engine, the drive shaft and a third rotary shaft, and that outputs or receives motive power via one of the three shafts based on the motive power that the remaining shafts receive or output; and a motor generator that outputs and receives motive power to and from the third rotary shaft.

20. The power output apparatus according to claim 18, wherein the electric power and motive power outputting/receiving section is a double-rotor motor that includes a first rotor connected to the output shaft of the internal combustion engine, and a second rotor connected to the drive shaft, and produces rotational motion using the relative rotation between the first rotor and the second rotor.

21. A vehicle on which the power output apparatus according to claim 13, wherein an axle is connected to the drive shaft.

22. A method of controlling a power output apparatus including: an internal combustion engine that outputs motive power to a drive shaft; a motor that outputs motive power to the drive shaft; and electricity storage device that supplies and receives electric power to and from the motor, comprising:
setting an output limit of the electricity storage device based on the status of the electricity storage device;
setting a required torque required to be output to the drive shaft;
while the internal combustion engine is stopped, setting the amount of increase in the torque to be output to the drive shaft in response to the increase in the required torque, based on the set output limit of the electricity storage device, until the internal combustion engine is started;
while the internal combustion engine is stopped, performing drive control of the motor so that the torque corresponding to the set required torque is output to the drive shaft, wherein the torque is limited by the set amount of increase and the set output limit of the electricity storage device, and, while the internal combustion engine is in operation, performing drive control of the internal combustion engine so that the torque corresponding to the set required torque is output to the drive shaft using at least the motive power output from the internal combustion engine;
setting first and second output limits based on the set output limit of the electricity storage device by correcting the set output limit of the electricity storage device so that the second output limit has a margin relative to the first output limit;
setting a torque command value of the motor so that the torque corresponding to the set required torque is output to the drive shaft, wherein the torque is limited by the set first output limit; and
performing drive control of the motor based on a resultant torque command value that is obtained by subjecting the set torque command value to predetermined variation moderation processing, wherein the torque is limited by the set second output limit.
